(19) United States
(12) Patent Application Publication
(10) Pub. No.: US 2010/0201088 A1
(43) Pub. Date: Aug. 12, 2010

(54) COMPRESSIVE COATINGS FOR ICE SKATE BLADES AND METHODS FOR APPLYING THE SAME

(76) Inventors: Martin Newman, Sharon, MA (US); Gary W. Filice, Moorpark, CA (US)

Correspondence Address: EDWARDS ANGELL PALMER & DODGE LLP, P.O. BOX 55874, BOSTON, MA, 02205, US

(21) Appl. No.: 12/367,246

(22) Filed: Feb. 6, 2009

(51) Int. Cl. A63C 1/30; B05D 3/12

(52) U.S. Cl. 280/11.18; 427/367

(57) ABSTRACT

A coated ice skate blade includes an ice skate blade having a plurality of sides and a bottom, and a compressive coating applied to the sides of the ice skate blade. Also provided is a method of producing a coated ice skate blade including receiving an ice skate blade having a plurality of sides and an unground bottom, applying a compressive coating to the sides and the bottom of the ice skate blade, and grinding the bottom of the ice skate blade to produce a radius of hollow. Another method includes receiving an ice skate blade having a plurality of sides and a ground bottom, and applying a compressive coating to the sides and the bottom of the ice skate blade.

### TECHNICAL FIELD

The present invention relates to compressive coatings applied to ice skate blades to reduce wear and methods of applying a compressive coating to ice skate blades.

### BACKGROUND

Ice skates of all varieties (e.g. figure skates, hockey skates, bandy skates, racing skates, and touring skates) include a blade which contacts the ice to propel the skater. Although referred to as a blade, an ice skate blade does not resemble the common shape of a blade, i.e., a knife. Rather, unlike the edge of a knife blade that is convex, the edge of an ice skate blade typically is concave.

Referring to FIG. 1, an ice skate blade 100 (shown cross-sectionally), when sharpened, typically includes a radius of hollow 102 formed through sharpening of the blade 100 with a curved sharpening wheel (not shown). Two edges 104a, 104b are formed where the radius of hollow 102 meets the sides 106a, 106b of the blade. These edges 104a, 104b allow the skater to glide along or grip the ice for propulsion or braking as may be desired.

Edges 104a and 104b, as described above, transmit all of the forces of the skater to the ice. While such forces can be substantial even when a skater is stationary, the forces are greatly magnified when a skater turns or stops. Additionally, edges 104a and 104b glide along the ice during skating, resulting in friction and wear. As a result, ice skates must be ground frequently to maintain sharp edges 104a, 104b.

Ice skate sharpening typically costs between five and fifteen dollars per pair of skates. The frequency of sharpening varies on personal preference, but can typically vary from sharpening after every skating session to once every forty or so skating sessions. As a result, the aggregate cost of skate sharpening can be substantial. Moreover, skate sharpening removes a portion of the blade, eventually necessitating replacement of the blade. Accordingly, it would be desirable to produce an ice skate blade that is more resistant to edge wear and provides superior gliding qualities.

There have been numerous attempts to improve blades for ice skates by the addition of various treatments and coatings. U.S. Pat. No. 5,255,929 granted to Lemelson teaches a diamond coating for use on a skate blade. Diamond coatings can be quite smooth and are known to be the hardest in existence. U.S. Pat. No. 3,918,728 granted to Stugger and Sprung teaches a snow ski including a metal edge having a thin layer of hard tungsten carbide particles fused thereto. U.S. Pat. No. 4,131,288 granted to Wilson teaches a skate blade including a strip of tungsten carbide that is induction-brazed to carbon steel. U.S. Pat. No. 5,516,556 granted to Baker and White teaches a polytetrafluoroethylene (PTFE) composition for burnishing an ice skate blade.

However, prior attempts at coating ice skates have not proved successful. Applicants understand that prior coatings were applied “in tension” such that the coating would shrink if the coating was removed from the blade. These coatings were vulnerable to cracking when struck or bent as commonly occurs during skating. Accordingly, the need for wear resistant ice skate blade remains.

### SUMMARY OF THE INVENTION

The present invention relates to compressive coatings applied to ice skate blades to reduce wear and methods of applying a compressive coating to ice skate blades.

One aspect of the invention provides a coated ice skate blade including an ice skate blade having two opposing sides and a bottom, and a compressive coating applied to the sides of the ice skate blade.

This aspect can have several embodiments. The opposing sides can be highly polished before the compressive coating is applied to the sides. The compressive coating can be applied to the bottom of the ice skate blade. The compressive coating can be applied to the bottom of the ice skate blade before the bottom of the blade is ground. The compressive coating can be applied to the bottom of the ice skate blade after the bottom of the blade is ground. The coated ice skate blade can include a top, wherein the compressive coating is applied to the top of the ice skate blade.

The compressive coating can have a hardness of greater or equal to about 3000 Vickers. The compressive coating can include a ceramic composition. The compressive coating can include a nitride ceramic composition. The compressive coating can include titanium nitride. The compressive coating can include titanium aluminum nitride.

The ice skate blade can wear more quickly than the compressive coating. The ice skate blade can have a hardness between about 50 and 60 on the Rockwell C scale. The compressive coating can have a hardness between about 67 and 90 on the Rockwell C scale. The coated sides can have an average roughness (RA) value less than or equal to about 0.8. The coated sides can have an average roughness (RA) value less than or equal to about 0.2. The compressive coating can have an average thickness of between 2 and 4 microns. The blade can be polished before coating is applied.

Another aspect of the invention provides a coated ice skate blade including two highly polished sides, a bottom, and a compressive coating applied to the sides.

This aspect of the invention can have several embodiments. The ice skate blade can be softer than the compressive coating. A difference in hardness between the compressive coating and the ice skate blade can be greater than about 40 on the Rockwell C scale. The ice skate blade can have a hardness of about 56 on the Rockwell C scale and the compressive coating can have a hardness of greater or equal to about 98 on the Rockwell C scale.

Another aspect of the invention provides a method of producing a coated ice skate blade. The method includes providing an ice skate blade including two opposing sides and an unground bottom, applying a compressive coating to the sides and the bottom of the ice skate blade, and grinding the bottom of the ice skate blade to produce a radius of hollow.

This aspect of the invention can have several embodiments. The step of grinding the bottom of the ice skate blade can remove a portion of the compressive coating. The compressive coating can include titanium aluminum nitride. The method can also include polishing the ice skate blade before applying the compressive coating.

Another aspect of the invention provides a method of producing a coated ice skating blade. The method includes providing an ice skate blade including two opposing sides and a ground bottom, and applying a compressive coating to the sides and the bottom of the ice skate blade.

This aspect of the invention can have several embodiments. The ground bottom of the ice skate blade can have been ground to a skater's preferences. The compressive coating can include titanium aluminum nitride. The method can include polishing the ice skate blade before applying the compressive coating.

### FIGURES

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts a cross-sectional view of a conventional ice skate blade.

FIG. 2 depicts the compressive stresses present within the compressive coatings described herein.

FIG. 3 depicts a cross-sectional view of a coated ice skate blade.

FIG. 4A depicts a cross-sectional view of a coated and unground ice skate blade.

FIG. 4B depicts the ice skate blade of FIG. 4A after the bottom of the blade is ground to form a radius of hollow.

FIG. 5A depicts an edge of a conventional ice skate blade as viewed at an angle from the bottom of the blade with an optical microscope at 100×.

FIG. 5B depicts an edge of a coated ice skate blade as viewed at an angle from the bottom of the blade with an optical microscope at 100×.

### DESCRIPTION OF THE INVENTION

The present invention relates to compressive coatings applied to ice skate blades to reduce wear and methods of applying a compressive coating to ice skate blades.

### Properties of Suitable Compressive Coatings

As used herein, the term “compressive coating” is a material which is formed in a compressive state when applied to a substrate (e.g. an ice skate blade). Such a coating would expand (at least slightly) if removed from the substrate. In other words, if a compressive coating is applied only to one side of thin blade, the coating would cause or tend to cause the blade to flex at least slightly to form a concave bend on the uncoated side. Of course, the degree of flexation will vary considerably depending on the type and thickness of the coating applied and the thickness and material of the blade. If the blade is thick, the actual bending may be non-existent, or so miniscule as to escape detection.

The presence or qualities of a compressive coating is measured with an Almen strip. An Almen strip is an SAE 1070 spring steel specimen. To test the presence or qualities of a compressive coating, an uncoated Almen strip is fastened to a block and coated. Upon removal from the block, the compressive stresses and/or surface plastic deformation caused by the coating will have caused the Almen strip to curve convexly on the coated surface (i.e. curve concavely on the uncoated surface). The height of this curvature when measured in a standard Almen gauge is called “arc height”. There are three standard Almen strips currently in use: “A” strips, which are 0.051′ thick; “C” strips, which are 0.094″ thick; and “N” strips, which are 0.031′ thick.

FIG. 2 provides a profile view of a ice skate 200 with a compressive coating. Arrows 202 illustrate the forces applied by the coating molecules to other coating molecules on the surface of the blade. Such forces are not necessarily orthogonal or present in only the x and y axes as depicted by arrows 202, as arrows 202 are merely provided to illustrate the concept of forces exerted by compressive coatings. Rather, forces can occur in all directions.

The compressive stress within the compressive coatings applied herein is approximately 3 gigapascals (GPa) and is believed to be caused by the shot peening effect of ion bombardment during the application of the coating to the substrate and the thermal expansion of the substrate during when heated during coating (and subsequent contraction during cooling).

Any compressive coating is suitable for application to an ice skate blade. Examples of materials suitable for use as compressive coatings in the present invention include ceramics such as titanium nitride (TiN), titanium carbon nitride (TiCN), titanium aluminum nitride (TiAlN), chromium nitride (CrN), which coatings are applied by chemical or physical vapor deposition. Other suitable materials include, but are not limited to, aluminum chromium nitride (AlCrN) and diamond coatings. Suitable coatings are available from a variety of distributors include coatings distributed under the BALINIT® trademark by Oerlikon Balzers of Balzers, Liechtenstein and coatings available from Guhring Inc. of Brookfield, Wis.; Ionbond of Madison Heights, Wis.; Swiss Tek Coatings, Inc. of New Berlin, Wis.; and BryCoat, Inc. of Oldsmar, Fla. Other materials can be applied as coatings so long as the resulting coating comprises materials with a residual compressive stress.

Such a compressive coating preferably includes the property of being hard, or more specifically, harder than a substrate material used for the ice skate blade. The hardness of a coating can be measured by a variety of tests including the Barcol, Brinell, Janka Wood, Knoop, Meyer, Rockwell, and Vickers tests. In some embodiments of the invention, the coating has a Vickers hardness value greater than or equal to about 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, 3500, 3550, 3600, 3650, 3700, 3750, 3800, 3850, 3900, 3950, 4000, 5000, 6000, 7000, 8000,9000, 10000, or 11000. Suitable coatings include, for example, BALINIT® FUTURA™ NANO, BALINIT® FUTURA™ TOP, and BALINIT® ALCRONA® coatings available from Oerlikon Balzers of Balzers, Liechtenstein.

In some embodiments, a multi-layer coating can be applied to the ice skate blade. For example, a first layer of titanium aluminum nitride can be applied to the ice skate blade. A second layer of aluminum chromium nitride can then be applied to the titanium aluminum nitride layer. Suitable multi-layer coatings include the BALINIT® ALDURA™ coating available from Oerlikon Balzers of Balzers, Liechtenstein.

In some embodiments, the coatings are colored. The color of the coating may be modified by adjusting the composition of the coating and/or the addition of one or more coloring additives, or by adding a surface layer of a colored material to the coating layer. Common coating colors include gold-yellow, blue-grey, anthracite, silver-grey, grey, black, violet-grey, dark grey, and copper. Colored coatings can enhance the aesthetic appeal of the ice skate blade.

To reduce friction, some embodiments of the invention incorporate smooth surface coatings. For example, the surface of the coating may have an RA (average roughness) value (in inches) of about 10.0, 9.5, 9.0, 8.5, 8.0, 7.5, 7.0, 6.5, 6.0, 5.5, 5.0, 4.5, 4.0, 3.5, 3.0, 2.5, 2.0, 1.5, 1.0, or 0.5. This measurement can reflect the smoothness of the coating as well as the smoothness of the substrate (e.g. from polishing as discussed herein.)

In some embodiments, the coating comprises nanoparticles (i.e. particles with at least one dimension less than 100 nm). Suitable coatings include the BALINIT® FUTURA™ NANO coating available from Oerlikon Balzers of Balzers, Liechtenstein. Such an application promotes smoothness and reduces the occurrence of chunking and spalling.

### Use of Polishing to Enhance Coating and Improve Glide

It is understood that prior attempts at coating ice skate blades did not incorporate polishing prior to coating. In various embodiments of the invention, a conventional ice skate blade is polished to high degree of smoothness before coating (e.g. 0.8 RA). The sides 106a, 106b and/or the radius of hollow 102 can be polished. Polishing can be effected using a variety of known methods and device such as an aluminum oxide wheel of a suitable grit to achieve the desired smoothness. Polishing also removes any burrs that may form on the blade edges 104a, 104b in embodiments where the radius of hollow 102 is ground before the coating is applied. The surface of the blade after polishing may have an RA (average roughness) value (in inches) of about 10.0, 9.5, 9.0, 8.5, 8.0, 7.5, 7.0, 6.5, 6.0, 5.5, 5.0, 4.5, 4.0, 3.5, 3.0, 2.5, 2.0, 1.5, 1.0, or 0.5 and/or a 5-10 μ-inch finish.

### Methods of Coating Ice Skating Blades

Methods of applying coatings to metals are well known in the art and thus only exemplary methods are described herein. Exemplary techniques include physical vapor deposition (PVD) and chemical vapor deposition (CVD). It will be appreciated by one of skill in the art that many other methods can be used and that certain methods may be advantageous for particular coating and/or blade materials.

In one method for coating an ice skating blade, the blade is first cleaned using soap and/or degreaser. The blades are cleaned by hand or by machine. In some embodiments, ultrasonic agitation is used to enhance the cleaning process.

Next, the blades are placed on rack for coating. The rack is placed in a vacuum chamber that is depressurized to about 10⁻³ torr. The blade is then further treated using argon ion bombardment. The chamber temperature is then adjusted to a desired temperature for coating. This desired temperature can vary for different coatings, but is generally known and available from the manufacturer of a desired coating. For example, the desired coating temperature for the BALINIT® FUTURA™ NANO coating is approximately 950° F.

A plasma discharge commences once the coating chamber reaches the desired coating temperature. Electrodes are used to ionize the coating atoms (e.g., Ti, Al, and N). An electrical bias is provided to the blade (e.g. via an electrode connected to the rack). The electrical bias drives the ionized atoms onto the substrate. In some embodiments, the blade is rotated in the vacuum chamber while the plasma discharge and electrical bias is applied. When the ionized atoms reach the surface of the blade, the atoms combine to produce the coating. The blades are cooled (e.g. in the vacuum chamber). A cooling time of six to twelve hours may be required in some embodiments; however shortened cooling times are within the scope of the invention.

### Applications of Coated Ice Skate Blades

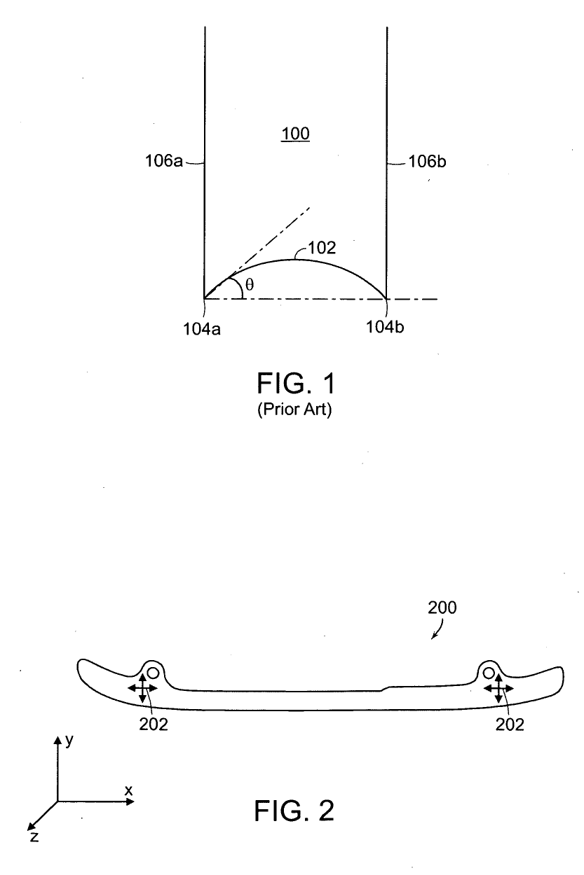

Referring again to FIG. 1, a cross-section of a conventional sharpened ice skate blade 100 is shown. The sharpened ice skate blade 100 includes a radius of hollow 102 formed through sharpening of the blade 100 with a curved sharpening blade (not shown). Two edges 104a, 104b are formed where the radius of hollow 102 meets the sides 106a, 106b of the blade. These edges 104a, 104b allow the skater to glide along or grip the ice for propulsion or braking as may be desired.

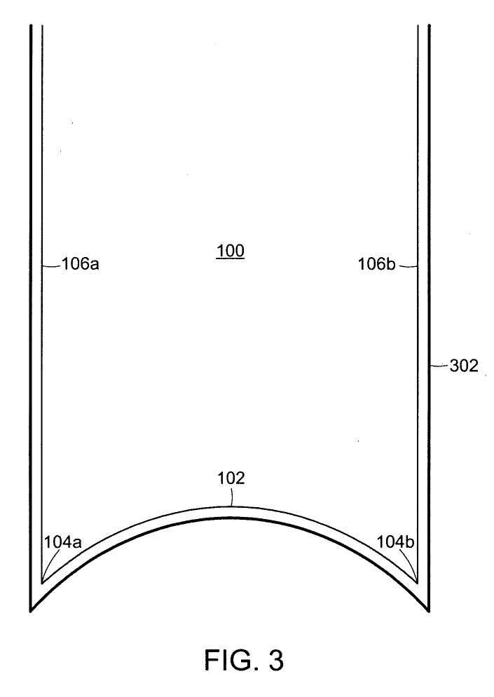

Referring now to FIG. 3, a coating 302 described herein are applied to at least the side surfaces of the ice skate blade 302. In the particular embodiment depicted in FIG. 3, the coating is also applied to the radius of hollow 102. In some embodiments, the coating is also applied to the top surfaces of the ice skate blade (not shown). (The space between the heavy lines representing the coating 302 and the thin lines representing the boundaries of skate 100 is illustrated for schematic purposes only.)

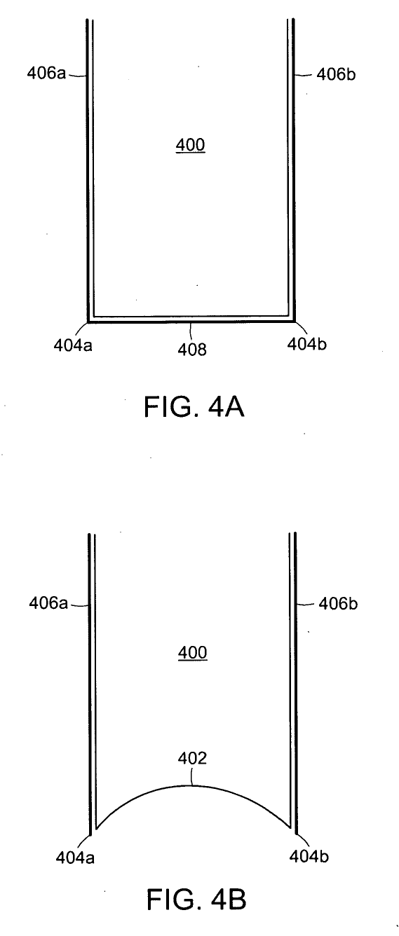

In typical embodiments, as depicted in FIG. 4, the coatings are applied to all surfaces (bottom 408, sides 406a, 406b, and optionally top (not shown) of an unground blade 400 according to the methods described above. After blade 400 cools, the bottom 408 of the blade 400 is ground to remove a portion of the blade including the coating and to form the radius of hollow 402. The particular wheels used for grinding can vary depending on the desired characteristics of the blade and/or the coating. In some embodiments, a silicon carbide, aluminum oxide, or diamond (e.g. 2-30 grit) grinding wheel is used. The size of the grinding wheel can be varied to produce a shallower or deeper hollow, as is known in the art. Typical grinding wheels have a six inch radius with respect the grinding wheel's axis of rotation. One important parameter to the performance of the ice skate is the curvature formed on the grinding surface of the wheel. This curvature imparts the radius of hollow 402. Typical radius of hollow values include ¼″, ⅜″, ½″, ⅝″, ¾″, ⅞″, 1″, 1¼″, and 1½″. Additionally, radius of hollow values may be refined further and expressed to the 16^{th} or 32^{nd} of an inch or in metric values. Suitable grinding wheels and apparatus for grinding ice skates are available, for example, from Wissota Manufacturing Company of Plymouth, Minn.

In this embodiment, the coating remains on the sides, while the substrate material is exposed in the hollow. During skating, the substrate (e.g. stainless steel, carbon steel, aluminum) typically will wear more quickly than the coating, thereby maintaining sharp edges. The relative hardness of the coating and the substrate can be adjusted to promote differential wear between the coated edges and the substrate hollow area. In some embodiments, the difference between the hardness of the coating and the hardness of the substrate is greater than about 40 when measured on the Rockwell C scale. For example, the substrate can have a hardness of between 40 to 70 (for example, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70) on the Rockwell C hardness scale, while the coating has a hardness between 60 to 100 (for example, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100) or over 100 on the Rockwell C hardness scale.

In other embodiments such as the embodiment depicted in FIG. 3, coatings are applied to the ice skate blade after the hollow has been ground to a skater's preferences. For example, a professional skater may grind multiple pairs of skates to reflect varying ice conditions, and then send the skates to a service center for application of a coating. In such an embodiment, the coating is applied to both the sides and the hollow.

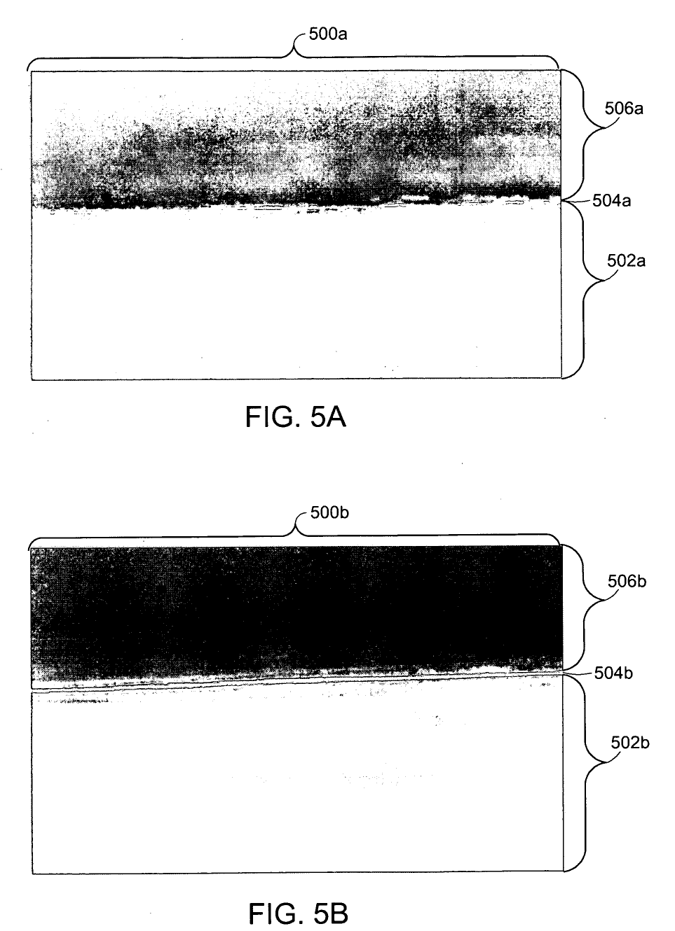

Finely polished ice skate blades coated with compressive coatings develop burrs at edges 404a, 404b that are miniscule when compared with conventional, uncoated ice skates. FIG. 5A depicts an edge 504a between side 506a and hollow 502a of a conventional ice skate blade 500a as viewed at an angle from the bottom of the blade with an optical microscope at 100×. FIG. 5B depicts an edge 504a between side 506b and hollow 502b of a coated ice skate blade 500b as viewed with the same power optical microscope. Edge 504b of coated and polished blade clearly is smoother, better defined, and more continuous than edge 504a of conventional, uncoated blade 100. The interruptions of edge 504a in the conventional blade 500a cause drag during the gliding portion of a skater's motion. In contrast, the smooth, continuous, and uninterrupted edge 504b or coated blade 504b generates less friction during the glide.

Compressive coatings are applied in a variety of thickness as tailored to desired characteristics. In particular embodiments, the coating thickness is approximately 1, 1.5, 2.0, 2.5, 3.0, 3.5, 4.0, 4.5, or 5.0 microns. Coatings thicker than five microns are also within the scope of this invention.

Coating thickness can be measured with a variety of devices and techniques known to those of skill in the art. Suitable non-destructive devices include magnetic pull-off gauges, magnetic and electromagnetic induction gauges, eddy current gauges, ultrasonic gauges, and micrometers. In addition to non-destructive devices, coating thickness can be measured through destructive testing in which the coating is measured by when viewing a cross-section of the blade. Suitable coating gauges are available from DeFelsko Corporation of Ogdensburg, N.Y. and Helmut Fischer GmbH of Sindelfingen-Maichingen, Germany.

Moreover, the application of a compressive coating reduces corrosion of the ice skate blade.

### Empirical Evidence

The efficacy of the present invention was tested by a professional ice hockey team. Members of the team were provided with ice skates having blades coated with the BALINIT® FUTURA™ NANO coating. The players used the ice skates over a series of practices and games ranging from 25-75 skating sessions and were allowed to sharpen the blades at will. Typically, professional hockey players sharpen conventional uncoated stainless steel ice skate blades before every skating session. In contrast, as shown in Table 1, the players using the coated blades of the present invention sharpened their skates substantially less frequently.

TABLE 1
Sharpening Data for Coated Ice Skate Blades

| | Players | | | | | | | | | |
|---|---|---|---|---|---|---|---|---|---|---|
| | A | B | C | D | E | F | G | H | I | J |
| Sessions | 75 | 42 | 25 | 30 | 40 | 42 | 44 | 60 | 78 | 82 |
| Sharpening | 4 | 4 | 1 | 10 | 10 | 1 | 1 | 2 | 5 | 3 |
| Frequency | | | | | | | | | | |
| Average | 18.75 | 10.5 | 25 | 3 | 4 | 42 | 44 | 30 | 15.6 | 27 |
| Sessions per | | | | | | | | | | |
| Sharpening | | | | | | | | | | |

Three of the players did not sharpen their skates for the entire test period. Other players sharpened their skates, on average, between once every three skating sessions to once every thirty skating sessions.

In additional testing by a recreational hockey player and referee, the ice skate blades used for 87.5 hours before sharpening was required. The tester indicated that he normally would have sharpened the blades after approximately 35 hours of skating.

### Equivalents

The foregoing specification and the drawings forming part hereof are illustrative in nature and demonstrate certain preferred embodiments of the invention. It should be recognized and understood, however, that the description is not to be construed as limiting of the invention because many changes, modifications and variations may be made therein by those of skill in the art without departing from the essential scope, spirit or intention of the invention. Also, various combinations of elements, steps, features, and/or aspects of the described embodiments are possible and contemplated even if such combinations are not expressly identified herein.

### IINCORPORATION BY REFERENCE

The entire contents of all patents, published patent applications, and other references cited herein are hereby expressly incorporated herein in their entireties by reference.

What is claimed is:

1. A coated ice skate blade comprising:
an ice skate blade comprising:
two opposing sides; and
a bottom; and
a compressive coating applied to the sides of the ice skate blade.

2. The coated ice skate blade of claim 1, wherein the opposing sides are highly polished before the compressive coating is applied to the sides.

3. The coated ice skate blade of claim 1, wherein the compressive coating is applied to the bottom of the ice skate blade.

4. The coated ice skate blade of claim 3, wherein the compressive coating is applied to the bottom of the ice skate blade before the bottom of the blade is ground.

5. The coated ice skate blade of claim 3, wherein the compressive coating is applied to the bottom of the ice skate blade after the bottom of the blade is ground.

6. The coated ice skate blade of claim 1 further comprising:
a top, wherein the compressive coating is applied to the top of the ice skate blade.

7. The coated ice skate blade of claim 1, wherein the compressive coating has a hardness of greater or equal to about 3000 Vickers.

8. The coated ice skate blade of claim 1, wherein the compressive coating comprises a ceramic composition.

9. The coated ice skate blade of claim 1, wherein the compressive coating comprises a nitride ceramic composition.

10. The coated ice skate blade of claim 1, wherein the compressive coating comprises titanium nitride.

11. The coated ice skate blade of claim 1, wherein the compressive coating comprises titanium aluminum nitride.

12. The coated ice skate blade of claim 1, wherein the ice skate blade wears more quickly than the compressive coating.

13. The coated ice skate blade of claim 1, wherein the ice skate blade has a hardness between about 50 and 60 on the Rockwell C scale.

14. The coated ice skate blade of claim 1, wherein the compressive coating has a hardness between about 67 and 90 on the Rockwell C scale.

15. The coated ice skate blade of claim 1, wherein the coated sides have an average roughness (RA) value less than or equal to about 0.8.

16. The coated ice skate blade of claim 1, wherein the coated sides have an average roughness (RA) value less than or equal to about 0.2.

17. The coated ice skate blade of claim 1, wherein the compressive coating has an average thickness of between 2 and 4 microns.

18. The coated ice skate blade of claim 1, wherein the blade is polished before coating is applied.

19. A coated ice skate blade comprising:
two highly polished sides;
a bottom; and
a compressive coating applied to the sides.

20. The coated ice skate blade of claim 19, wherein the ice skate blade is softer than the compressive coating.

21. The coated ice skate blade of claim 20, wherein a difference in hardness between the compressive coating and the ice skate blade is greater than about 40 on the Rockwell C scale.

22. The coated ice skate blade of claim 20, wherein the ice skate blade has a hardness of about 56 on the Rockwell C scale and the compressive coating has a hardness of greater or equal to about 98 on the Rockwell C scale.

23. A method of producing a coated ice skate blade comprising:
providing an ice skate blade comprising:
two opposing sides; and
an unground bottom;
applying a compressive coating to the sides and the bottom of the ice skate blade; and
grinding the bottom of the ice skate blade to produce a radius of hollow.

24. The method of claim 23, wherein the step of grinding the bottom of the ice skate blade removes a portion of the compressive coating.

25. The method of claim 23, wherein the compressive coating comprises titanium aluminum nitride.

26. The method of claim 23, further comprising:
polishing the ice skate blade before applying the compressive coating.

27. The method of producing a coated ice skating blade comprising:
providing an ice skate blade comprising:
two opposing sides; and
a ground bottom; and
applying a compressive coating to the sides and the bottom of the ice skate blade.

28. The method of claim 27, wherein the ground bottom of the ice skate blade has been ground to a skater's preferences.

29. The method of claim 27, wherein the compressive coating comprises titanium aluminum nitride.

30. The method of claim 27, further comprising:
polishing the ice skate blade before applying the compressive coating.
